(19) United States
(12) Patent Application Publication
(10) Pub. No.: US 2008/0165085 A1
(43) Pub. Date: Jul. 10, 2008

(54) Elongated Display Fibers and Display Made Thereof

(75) Inventors: Leendert Van Der Tempel, Eindhoven (NL); Mark Thomas Johnson, Eindhoven (NL); Kirk Jan Broer, Eindhoven (NL); Michel Marcel Jose Decre, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,233

(22) PCT Filed: Feb. 22, 2005
(86) PCT No.: PCT/IB05/50646

§ 371 Date: Aug. 22, 2006

(30) Foreign Application Priority Data
Mar. 2, 2004 (EP) 04100821.0

(51) Int. Cl. G09G 3/16

(52) U.S. Cl. 345/48

(57) ABSTRACT

The present invention relates to an elongated display fiber (1) comprising an optical fiber body (2) having a plurality of pixel positions distributed along the length of said fiber (1). At least one light source (3) is arranged to selectively illuminate said fiber (1) from at least one end thereof. Addressing means are operably associated with said fiber for sequential addressing of one of each of said pixel positions. The display fiber (1) further comprises means for selectively causing said fiber (1) to emit light at said addressed one of said pixel positions. The present invention further relates to a display apparatus (11) comprising at least one elongated display fiber (1) according to the present invention.

### BACKGROUND OF THE INVENTION

1. Field of the Invention

The present patent application relates to the field of elongated display fibers, and particularly to displays comprising a plurality of such elongated display fibers.

2. Description of the Related Art

Electronic displays are used to present to a user various forms of display information, such as text, graphics, and video, as pixelized images. The presentation of pixelized display information may be an essential function of an electronic device, such as usually is the case with personal computers. Pixelized display information can also be used to enhance the features of an electronic device, such as enabling interaction between a user and an electronic device.

A number of electronic display technologies are available, each having specific attributes that limit their application. Cathode Ray Tubes (CRTs), for instance, are widely used for computer monitors and televisions. CRTs have good color, contrast, and brightness, as well as being a mature, economical technology. CRTs are not particularly compact, being limited by the geometries imposed by its electron gun and pixel elements formed at substantially perpendicular relation to the electron gun. Moreover, the vacuum requirements of a CRT dictate a heavy glass construction. Thus, the size, weight, rigid fragile construction, high acceleration voltages and power consumption of CRTs limits their use in portable applications.

As an alternative to CRTs, plasma screen technology allows for a display flatter and wider than CRTs and rear projection televisions. However, plasma screen technology is difficult to manufacture, and thus expensive. Moreover, although flatter than CRTs, plasma screens have similar limitations as do CRTs for high drive voltages weight and rigidity. Consequently, plasma screen displays are used in certain notebook computers and relatively expensive portable devices.

Various other technologies allow for flat, lighter weight, and lower power consumption than CRTs, appropriate to more portable applications. Liquid Crystal Displays (LCD) and active matrix LCDs (AMLCD) are e.g. widely used in notebook computers and personal digital assistant (PDA) products. To provide a degree of flexibility and resistance to impact, plastic LCDs are known. Although LCDs are generally less expensive than other displays of comparable size they are however generally too expensive to incorporate into limited life, disposable electronic products.

Previously known patent publication U.S. Pat. No. 6,259,838 B1 relates to a display as for images and/or information which comprises a plurality of linearly addressed light-emitting fibers disposed in side-by-side arrangement to define a viewing surface. Each light-emitting fiber includes a plurality of light-emitting elements disposed along its length which is linearly addressed by signals provided by a drive circuit at one end thereof. Linear addressing signals are either optical signals or electrical signals, and may be frequency modulated, digitally encoded or analog encoded. A detector associated with each pixel detects the linear addressing signal and decodes it to activate and deactivate organic or inorganic light-emitting material elements. Thus, the light-emitting elements emit light to display a pixel or sub-pixel of the image and/or information. The light-emitting fiber may include a transparent fiber as substrate for propagating the optical signals there through and may include electrical conductors disposed along its length for propagating the electrical signals.

A drawback of the above described display according to U.S. Pat. No. 6,259,838 B1 is that the fiber must be equipped with a plurality of detectors, one associated with each pixel. These detectors are necessary for detecting the linear addressing signals, and also needed to be able to decode the detected signals and provide for activation or deactivation of the associated light emitting elements. Thus this adds to the complexity of the fiber, which renders it more complicated to produce and increases the costs associated therewith.

Accordingly, there is a need for a light weight, low voltage, inexpensive display element having few connections, which display element can be produced more economically and which is suitable for use in displays for portable electronic devices and a variety of applications.

### SUMMARY OF THE INVENTION

Taking the above into mind, it is an object of the present invention to provide an improved elongated display fiber, comprising an optical fiber body having a plurality of pixel positions distributed along the length of said fiber, by which a light weight, inexpensive display element, which can be produced economically, requires a low number of connections and drivers, and which is suitable for use in displays for portable electronic devices as well as wearable displays and a variety of applications can be achieved.

This object is achieved in accordance with the characterizing portion of claim 1.

Thanks to the provision of at least one light source arranged to selectively illuminate said fiber with light from at least one end thereof and means operably associated with said fiber for sequential addressing of one of each of said pixel positions, as well as means for selectively causing said fiber to emit said light at said addressed one of said pixel positions the above objectives are met.

Preferred embodiments are listed in the dependent claims.

Addressing of a pixel position to be illuminated can be facilitated through said fiber being an annular fiber, an electro wetting material being comprised inside of said annular fiber and arranged such that a drop or meniscus thereof can be addressed to be positioned by means of electro wetting at one of said pixel positions, said drop or meniscus being arranged to scatter and couple the light out of said fiber at said addressed pixel position.

Addressing can further be facilitated through said annular fiber being filled with two immiscible electro wetting liquids, a first transparent liquid having refractive indices making it a light guide and a second light scattering liquid, said light scattering liquid preferably being a drop of limited length in order to reduce viscous dissipation.

In order to further facilitate addressing said annular fiber can be provided with a patterned conductive transparent outer coating and a phobic inner coating, said patterned conductive transparent outer coating (6) being segmented and each segment i being electrically connected to a segment i+n, said segment groups being arranged to be charged consecutively by said addressing means for positioning by means of electro wetting said drop or meniscus of said electro wetting material (4) at said one addressed pixel position.

Alternatively addressing can be facilitated through said fiber comprising: slightly conical sections distributed along the length of said fiber; said addressing means comprising optical beam steering means arranged to scan minute angels in respect to a centerline of said fiber; said means for selectively causing said fiber to emit said light at said one addressed pixel position comprising means for controlling the illumination angle in respect to the centerline of said fiber such that a beam from said at least one light source will be reflected inside said fiber such that it increases its angle of incidence with each reflection until said angle of incidence reaches the Brewster angle and said beam escapes said fiber at said one pixel position addressed through the original angel of incidence in respect to the centerline of said fiber.

In order to scatter said escaping beam said fiber can be provided with a semitransparent cladding, either through modification of outer surface roughness or addition of a scattering (milky) coating.

As a further alternative, addressing can be achieved through said fiber being a multi-layer fiber consisting of multiple light guiding layers separated by layers with a lower refractive index; said addressing means comprising optical beam steering means arranged to selectively illuminate one of said layers; said layers having different lengths corresponding to different ones of said pixel positions for causing said fiber to emit said light at said addressed one of said pixel positions corresponding to said illuminated layer.

In order to facilitate production and increase the light emitting area said layers can be provided with tapered ends.

In order to facilitate coupling in of light into said fiber said layers can be given different lengths at said one fiber end arranged to be illuminated by said at least one light source.

In order to provide for color display capabilities said at least one light source can comprise a combination of multiple, preferably three, color, time modulated light sources, such as light emitting diodes (LEDs).

A display apparatus comprising at least one elongated display fiber can be achieved through associating display driver means with the display fiber.

An increased size viewing surface of the display apparatus can be achieved through disposing a plurality of display fibers, each with associated display driver means, in a side by side arrangement.

In order to provide a structurally defined viewing surface the display apparatus can be provided with a substrate on which said plurality of fibers are disposed in side by side arrangement.

A viewing surface of the display apparatus providing for improved quality image reproduction can be achieved through disposing the fibers as an array of essentially parallel fibers making up the viewing surface.

In order to enable use of the display apparatus for providing a viewing surface on garments and various other textile like applications the fibers can be disposed in the warp or weft of a fabric.

In an alternative for enabling use of the display apparatus for providing a viewing surface on garments and various other textile like applications the fibers can be disposed as meandering fibers in a fabric.

### BRIEF DESCRIPTION OF THE DRAWINGS

In the drawings, wherein like reference characters denote similar elements throughout the several views:

FIG. 1 discloses a schematic view of a first embodiment of a display fiber in accordance with the present invention;

FIG. 2 discloses an alternative configuration of the display fiber in accordance with the first embodiment of the present invention;

FIG. 3 discloses yet an alternative configuration of the display fiber in accordance with the first embodiment of the present invention;

FIG. 4 a schematic view of a second embodiment of a display fiber in accordance with the present invention;

FIG. 5 a schematic view of a third embodiment of a display fiber in accordance with the present invention;

FIG. 6 discloses an alternative configuration of the display fiber in accordance with the third embodiment of the present invention;

FIG. 7 illustrates partially still an alternative configuration of the display fiber in accordance with the third embodiment of the present invention;

FIG. 8 discloses a schematic view of a first embodiment of a display apparatus in accordance with the present invention;

FIG. 9 discloses a schematic view of a second embodiment of a display apparatus in accordance with the present invention.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PRESENTLY PREFERRED EMBODIMENTS

In accordance with the present invention an elongated display fiber 1 comprises an optical fiber body 2 having a plurality of pixel positions distributed along the length thereof. The fiber 1 is preferably a weavable and wearable polymer fiber, of which it is possible to produce a textile like fabric. At least one light source 3 is arranged to selectively illuminate said fiber 1 with light from at least one end thereof. In all of the drawings the light is illustrated by dotted arrows. Addressing means (not shown) are operably associated with said fiber 1 for sequential addressing of one of each of said pixel positions. Said fiber 1 further comprises means for selectively causing said fiber to emit light at said addressed one of said pixel positions.

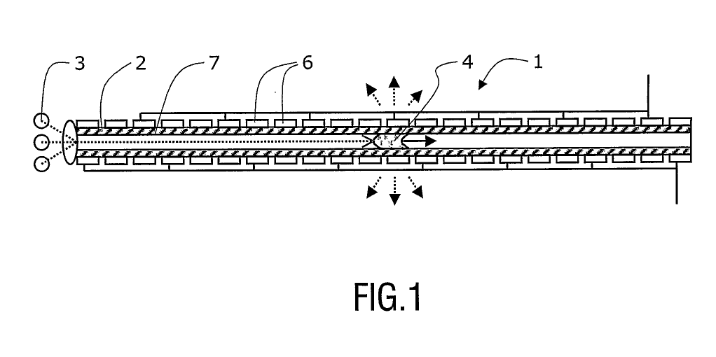

The fiber 1 in accordance with a first embodiment, as shown in FIG. 1, is an annular fiber. An electro wetting material 4 is comprised inside of said annular fiber and arranged such that a drop or meniscus thereof can be addressed to be positioned, by means of electro wetting, at one of said pixel positions. The drop or meniscus is arranged to scatter and couple the light out of said fiber 1 at said addressed pixel position.

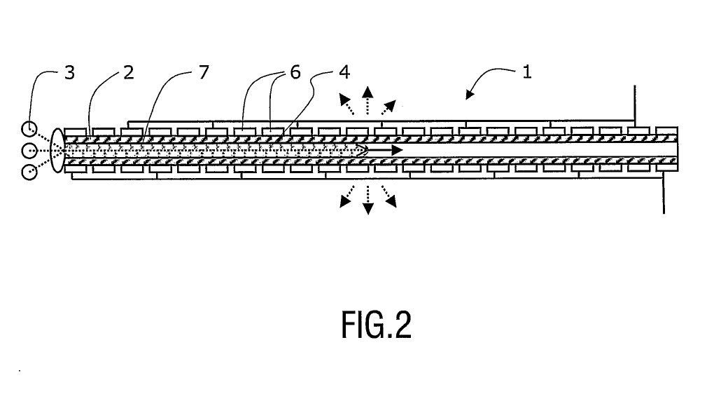

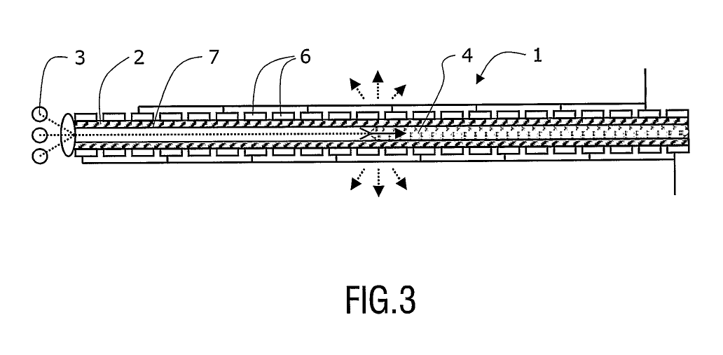

The annular fiber 1 is preferably filled with two immiscible liquids, a first transparent liquid having refractive indices making it a light guide and a second light scattering liquid. The light scattering liquid is preferably a drop of limited length in order to reduce viscous dissipation. However, as illustrated in FIG. 2, the annular fiber can also comprise only one transparent liquid 4 a scattering meniscus of which is brought to move by electro wetting or, as illustrated in FIG. 3, only one scattering liquid 4 a meniscus of which is brought to move by electro wetting with the remainder of the annulus being empty and operating as a light guide. Movement of the electro wetting material 4 is illustrated in FIGS. 1, 2 and 3 by a respective solid arrow. In applications including light sources 3 at both ends of said fiber 1, two drops or menisci are appropriate.

Further the annular fiber 1 in accordance with the embodiments of FIGS. 1, 2 and 3 is preferably provided with a patterned conductive transparent outer coating 6 (shown in an exaggerated scale in FIGS. 1, 2 and 3 for clarity) and a phobic inner coating 7. The patterned conductive transparent outer coating 6 being segmented and each segment “i” is, for example, electrically connected to a segment “i+n” e.g. as shown in FIGS. 1, 2 and 3 with “i”=three. These segment groups are arranged to be charged consecutively by the addressing means for positioning, by means of electro wetting, said drop or meniscus of the electro wetting material 4 at said one addressed pixel position. Through this arrangement the fluid 4 can be brought to move at about a 50 Hz scanning rate which is synchronous with the light source or light sources 3, either to and fro in a fiber 1 or continuously in a fiber loop. It is estimated that using current state of the art electro wetting technology it will hereby be possible to provide a combination of sufficient scanning rates for display quality with an annulus diameter sufficiently small to provide for flexibility and wearability of the fiber 1.

For certain applications, such as display of colors, said at least one light source 3 can comprise a combination of multiple, preferably three, color, time modulated light sources 3, such as light emitting diodes (LEDs). Furthermore, two light sources 3 can be arranged to selectively illuminate said fiber 1 from both ends thereof. The scattering drop or meniscus is preferably brought to move by electro wetting in the annular fiber at a scanning rate of 10-120 Hz, providing a time distance basis.

The display fiber 1 according to this first embodiment typically only requires drivers for the time modulated light source or light sources 3, e.g. three LED drivers, and an electro wetting driver, minimizing the number of connections to the fiber 1 required.

For applications where said elongated display fiber 1 in accordance with the first embodiment is used in a configuration where it is rotation fixed it can further comprise a back reflector (not shown) covering up to approximately 180° of a circumference of said fiber 1 in order to enhance the brightness in front of the fiber 1. As an alternative a back reflector can be arranged behind said fiber 1 in corresponding manner in order to enhance the brightness in front of the fiber 1.

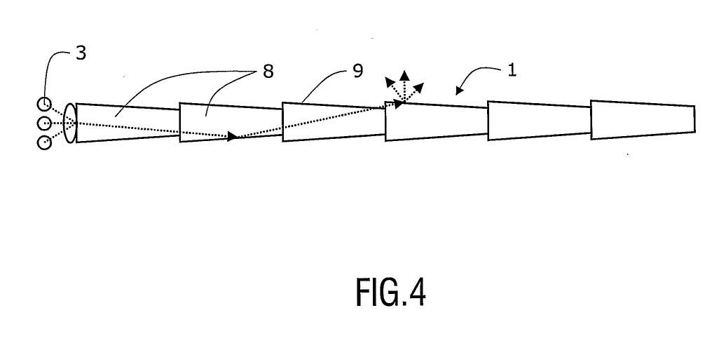

In FIG. 4 is illustrated a second embodiment of an elongated display fiber 1 comprising an optical fiber body having a plurality of pixel positions distributed along the length thereof. Also this fiber 1 is preferably a weavable and wearable polymer fiber, of which it is possible to produce a textile like fabric. At least one light source 3 is arranged to selectively illuminate said fiber 1 from at least one end thereof. Addressing means (not shown) are operably associated with said fiber 1 for sequential addressing of one of each of said pixel positions. Said fiber 1 further comprises means for selectively causing said fiber 1 to emit light at said addressed one of said pixel positions.

The display fiber 1 in accordance with this second embodiment comprises slightly conical fiber sections 8 distributed along the length of said fiber 1. For certain applications, such as display of colors, said at least one light source 3 can comprise a combination of multiple, preferably three, color, time modulated light sources 3, such as light emitting diodes (LEDs). In this embodiment the addressing means comprises optical beam steering means arranged to scan minute angles in respect to a centerline of the fiber 1. The means for selectively causing said fiber 1 to emit light at said one addressed pixel position comprises means for controlling the illumination angle in respect to the centerline of the fiber 1 such that a beam from said at least one light source 3 will be reflected inside the fiber 1 such that it increases its angle of incidence with each reflection until said angle of incidence reaches the Brewster angle and said beam escapes said fiber 1 at said one pixel position. Addressing of the pixel position to be illuminated is thus determined through controlling the original angel of incidence in respect to the centerline of the fiber 1.

In order to scatter said escaping beam the display fiber 1 has a semitransparent cladding 9 provided either through modification of outer surface roughness or addition of a scattering (milky) coating.

As for the fibers in accordance with the previous embodiment, for applications where said elongated display fiber 1 in accordance with the second embodiment is used in a configuration where it is rotation fixed it can further comprise a back reflector (not shown) covering up to approximately 180° of a circumference of said fiber 1 in order to enhance the brightness in front of the fiber 1. As an alternative a back reflector can be arranged behind said fiber 1 in corresponding manner in order to enhance the brightness in front of the fiber 1.

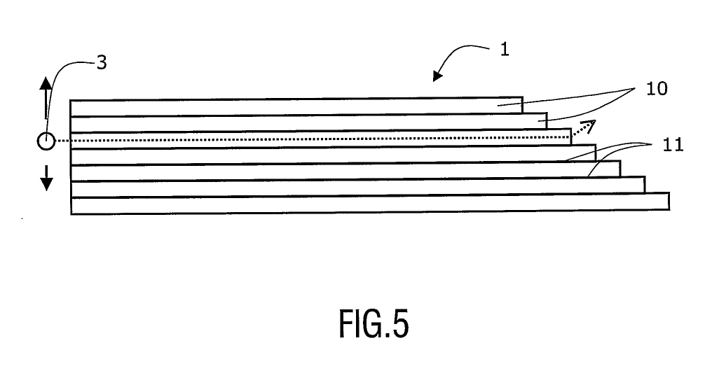

A third embodiment of an elongated display fiber 1 is shown in FIG. 5. Also this display fiber 1 comprises an optical fiber body having a plurality of pixel positions distributed along the length thereof. Also this fiber 1 is preferably a weavable and wearable polymer fiber, of which it is possible to produce a textile like fabric. At least one light source 3 is arranged to selectively illuminate said fiber 1 from at least one end thereof. Addressing means (not shown) are operably associated with said fiber 1 for sequential addressing of one of each of said pixel positions. Said fiber further comprises means for selectively causing said fiber 1 to emit light at said addressed one of said pixel positions.

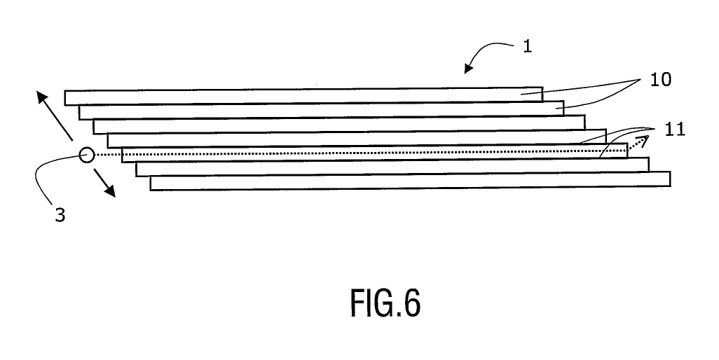

The display fiber 1 in accordance with this third embodiment is a multi-layer fiber consisting of multiple light guiding layers 10 separated by layers 11 with a lower refractive index. For certain applications, such as display of colors, said at least one light source 3 can comprise a combination of multiple, preferably three, color, time modulated light sources 3, such as light emitting diodes (LEDs). The addressing means comprises optical beam steering means (illustrated schematically in FIGS. 5 and 6 by the full arrows) arranged to selectively illuminate one of the layers 10. The layers 10 have different lengths corresponding to different ones of said pixel positions for causing the fiber 1 to emit light at said addressed one of said pixel positions corresponding to said illuminated layer 10.

In order to widen tolerances for the beam steering the layers 10 can be given different lengths also at said one fiber end arranged to be illuminated by said at least one light source 3 for coupling light into the fiber, as is illustrated in FIG. 6.

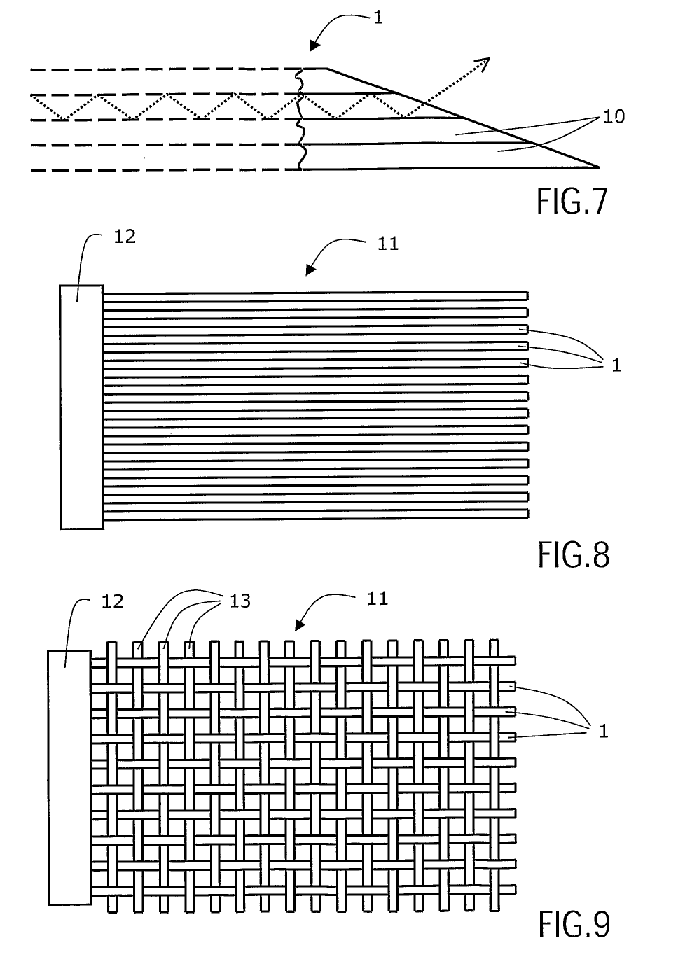

In order to increase the light emitting area the layers 10 can be arranged to have tapered ends, as is illustrated in FIG. 7.

As for the fibers in accordance with the previous embodiments, for applications where said elongated display fiber 1 in accordance with the third embodiment is used in a configuration where it is rotation fixed it can further comprise a back reflector (not shown) covering up to approximately 180° of a circumference of said fiber 1 in order to enhance the brightness in front of the fiber 1. As an alternative a back reflector can be arranged behind said fiber 1 in corresponding manner in order to enhance the brightness in front of the fiber 1.

The present invention shall also encompass a display apparatus 11 comprising at least one elongated display fiber 1 in accordance with the present invention as well as an associated display driver means 12.

In a first embodiment, as illustrated schematically in FIG. 8, the display apparatus 11 comprises a plurality of elongated display fibers 1 disposed in a side by side arrangement to define a viewing surface thereof. If required for a specific application, the display fibers 1 can be disposed on a backing substrate (not shown), which backing substrate may be a flexible substrate. The fibers 1 are preferably disposed as an array of essentially parallel fibers 1, for producing a uniform viewing surface. Each fiber 1 is associated with display driver means 12 connected to one end thereof.

In a second embodiment, as illustrated schematically in FIG. 9, the display apparatus 11 comprises a plurality of elongated display fibers 1 disposed in a fabric along with other fibers 13 thereof, preferably a textile fabric, defining a viewing surface thereof. The fibers 1 can be disposed in a warp or weft of the fabric or alternatively disposed as meandering fibers 1 in the fabric. As in the first embodiment, each fiber 1 is associated with display driver means 12 connected to one end thereof. The arrangement in accordance with this second embodiment is very advantageous for producing wearable displays.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An elongated display fiber (1), comprising an optical fiber body (2) having a plurality of pixel positions distributed along the length of said fiber (1), characterized in that it further comprises: at least one light source (3) arranged to selectively illuminate said fiber (1) with light from at least one end thereof; means operably associated with said fiber for sequential addressing of one of each of said pixel positions; means for selectively causing said fiber (1) to emit said light at said addressed one of said pixel positions.

2. The elongated display fiber (1) of claim 1, characterized in said fiber (1) being an annular fiber, an electro wetting material (4) being comprised inside of said annular fiber (1) and arranged such that a drop or meniscus thereof can be addressed to be positioned by means of electro wetting at one of said pixel positions, said drop or meniscus being arranged to scatter and couple said light out of said fiber (1) at said addressed pixel position.

3. The elongated display fiber (1) of claim 2, characterized in said annular fiber (1) being filled with two immiscible electro wetting liquids, a first transparent liquid having refractive indices making it a light guide and a second light scattering liquid, said light scattering liquid preferably being a drop of limited length in order to reduce viscous dissipation.

4. The elongated display fiber (1) of claim 2, characterized in said annular fiber being provided with a patterned conductive transparent outer coating (6) and a phobic inner coating (7), said patterned conductive transparent outer coating (6) being segmented and each segment i being electrically connected to a segment i+n, said segment groups being arranged to be charged consecutively by said addressing means for positioning by means of electro wetting said drop or meniscus of said electro wetting material (4) at said one addressed pixel position.

5. The elongated display fiber (1) of claim 1, characterized in said fiber (1) comprising: slightly conical sections (8) distributed along the length of said fiber (1); said addressing means comprising optical beam steering means arranged to scan minute angels in respect to a centerline of said fiber (1); said means for selectively causing said fiber to emit said light at said one addressed pixel position comprising means for controlling the illumination angle in respect to the centerline of said fiber such that a beam from said at least one light source (3) will be reflected inside said fiber (1) such that it increases its angle of incidence with each reflection until said angle of incidence reaches the Brewster angle and said beam escapes said fiber (1) at said one pixel position addressed through the original angel of incidence in respect to the centerline of said fiber (1).

6. The elongated display fiber (1) of claim 5, characterized in said fiber in order to scatter said escaping beam having a semitransparent cladding (9) provided either through modification of outer surface roughness or addition of a scattering coating.

7. The elongated display fiber (1) of claim 1, characterized in said fiber being a multi-layer fiber consisting of multiple light guiding layers (10) separated by layers (11) with a lower refractive index; said addressing means comprising optical beam steering means arranged to selectively illuminate one of said layers (10); said layers (10) having different lengths corresponding to different ones of said pixel positions for causing said fiber (1) to emit said light at said addressed one of said pixel positions corresponding to said illuminated layer (10).

8. The elongated display fiber (1) of claim 7, characterized in said layers (10) having tapered ends for increasing the light emitting area.

9. The elongated display fiber (1) of claim 7, characterized in said layers (10) having different lengths at said one fiber end arranged to be illuminated by said at least one light source (3).

10. The elongated display fiber (1) of claim 1, characterized in said at least one light source (3) comprising a combination of multiple, preferably three, color, time modulated light sources, such as light emitting diodes (LEDs).

11. A display apparatus (11) characterized in that it further comprises at least one elongated display fiber (1) according to claim 1 and an associated display driver means (12).

12. The display apparatus (11) of claim 1 characterized in that it further comprises a plurality of said fibers (1) disposed in a side by side arrangement to define a viewing surface of said display apparatus (11).

13. The display apparatus (11) of claim 12 characterized in that it further comprises a substrate on which said plurality of fibers (1) are disposed in said side by side arrangement.

14. The display apparatus (11) of claim 11 characterized in that it further comprises said plurality of said fibers (1) disposed as an array of essentially parallel fibers (1).

15. The display apparatus (11) of claim 11 characterized in that it further comprises a plurality of said fibers (1) disposed in a warp or weft of a fabric.

16. The display apparatus (11) of claim 11 characterized in that it further comprises a plurality of said fibers (1) disposed as meandering fibers in a fabric.

17. The display apparatus of claim 15 characterized in said fabric being a textile.
